(19) United States
(12) Patent Application Publication
(10) Pub. No.: US 2025/0063452 A1
(43) Pub. Date: Feb. 20, 2025

(54) DYNAMIC PROFILE SWITCHING

(71) Applicant: CUBIC TELECOM LIMITED, Dublin (IE)

(72) Inventors: Ronan O'Hurley, Dublin (IE); Andrei Marian Hagiu, Dublin (IE); Nick Nugent, Dublin (IE); Barry Napier, Dublin (IE)

(21) Appl. No.: 18/933,881

(22) Filed: Oct. 31, 2024

Related U.S. Application Data
(63) Continuation-in-part of application No. PCT/EP2024/061968, filed on Apr. 30, 2024.

(30) Foreign Application Priority Data
May 3, 2023 (GB) 2306560.0

(51) Int. Cl. H04W 36/30; H04W 36/14; H04W 76/10; H04W 88/06

(52) U.S. Cl. CPC H04W 36/304; H04W 36/14; H04W 76/10; H04W 88/06

(57) ABSTRACT

Managing network connections at a mobile device comprises: obtaining connectivity data and location data from the mobile device; determining that the mobile device is connected to a current network using an IMSI of a current profile; determining whether the current network is a preferred network and/or whether the current profile is a preferred profile based on the Quality of Experience data and the location data; and instructing the mobile device to connect to the preferred network using an IMSI of the preferred profile in response to determining that the current network is not the preferred network and/or in response to determining that the current profile is not the preferred profile. The mobile device comprises an eSIM comprising at least a first profile. The first profile comprises at least one IMSI. The mobile device is configured for communication with a connection manager which is configured for monitoring QoE data.

### CROSS-REFERENCE TO RELATED APPLICATIONS

This Application is a Continuation-in-Part of PCT/EP2024/061968, filed Apr. 30, 2024, which claims benefit of GB 2306560.0, filed May 3, 3023.

### FIELD OF THE INVENTION

The present application relates to a method and system for managing network connections at a mobile device. In particular, the present application relates to a method and system for dynamic profile switching at a mobile device.

### BACKGROUND

Subscriber Identity Module, SIM, cards are commonly used to enable a mobile device to connect to a cellular network operated by a Mobile Network Operator, MNO. The MNO can identify and grant network access to the mobile device by inspecting an international mobile subscriber identifier, IMSI, stored on the SIM card. Where a mobile device is within the geographical coverage of its ‘home’ MNO network (i.e. the network of the MNO to which the IMSI belongs), it will be able to communicate data over that home network.

To maintain network connectivity when the mobile device moves outside the range of its home network, for example when crossing an international border, devices may be allowed to ‘roam’. Where a roaming agreement exists between the home MNO and a new local MNO, no loss of service will be experienced at the mobile device. Where no roaming agreement is in place, or in cases where roaming is time-limited, maintaining network connectivity requires swapping the SIM card in the mobile device with a new SIM card provided by the new local MNO.

An embedded SIM, eSIM, provides an alternative to such swapping of physical SIM cards. An eSIM comprises software installed onto an embedded Universal Integrated Circuit Card, eUICC, in a mobile device. Once a profile having an IMSI has been installed on the eUICC, it operates in much the same way as a physical SIM card. Multiple profiles can be loaded onto the eSIM at the manufacturing stage to allow the mobile device to connect to a plurality of networks operated by different MNOs. However, the device manufacturer may have no knowledge of where the mobile device will ultimately be deployed. Overcoming this problem by providing a large number of pre-installed eSIM profiles, or indeed a large number of physical SIM cards, would be impractical. Furthermore, arbitrary and unmanaged switching between a finite number of profiles may result in non-optimal connectivity and/or increased costs, for example when the cost of using a local profile is greater than roaming charges incurred by using another, non-local, profile. There exists a need for a way of managing network connections at mobile devices, particularly mobile devices which may be deployed in one or more of a large number of territories.

### SUMMARY OF THE INVENTION

Accordingly, a first embodiment provides a method as defined in claim 1. A further embodiment provides a connection manager defined in claim 11. A further embodiment provides a method as defined in claim 14. Systems configured to carry out the methods are also provided.

Advantageously, the present methods, apparatus and systems can be used to manage network connections at a mobile device effectively, and to minimise service disruption at a mobile device.

Further advantageously, the present methods, apparatus and systems allow a mobile device to maintain network connectivity, even when the mobile device moves across one or more borders,

Further advantageously, the present methods, apparatus and systems allow a mobile device to seamlessly connect to multiple cellular networks operated by different MNOs, for example while roaming.

Further advantageously, the present methods, apparatus and systems allow a mobile device to ensure best possible Quality of Experience.

Further advantageous embodiments are provided in the dependent claims.

### BRIEF DESCRIPTION OF THE DRAWINGS

The present application will now be described with reference to the accompanying drawings in which:

FIG. 1 is a schematic showing a system in accordance with the present invention.

FIG. 2A is a schematic showing a mobile device connected to a network provided by a first MNO.

FIG. 2B is a schematic showing the mobile device of FIG. 2A connected to a network provided by a second MNO.

FIG. 3 is a schematic showing a method in accordance with the present invention.

FIG. 4 is a schematic showing a further method in accordance with the present invention.

FIG. 5 is a schematic showing a further method in accordance with the present invention.

FIG. 6 is a schematic showing a further method in accordance with the present invention.

FIG. 7 is a schematic showing a further method in accordance with the present invention.

FIG. 8 is a schematic showing a further method in accordance with the present invention.

FIG. 9A is a schematic showing a mobile device connected to a network provided by a first MNO.

FIG. 9B is a schematic showing the mobile device of FIG. 9A connected to a network provided by a second MNO.

FIG. 10 is a schematic showing a further method in accordance with the present invention.

FIG. 11 is a schematic showing a further method in accordance with the present invention.

### DETAILED DESCRIPTION

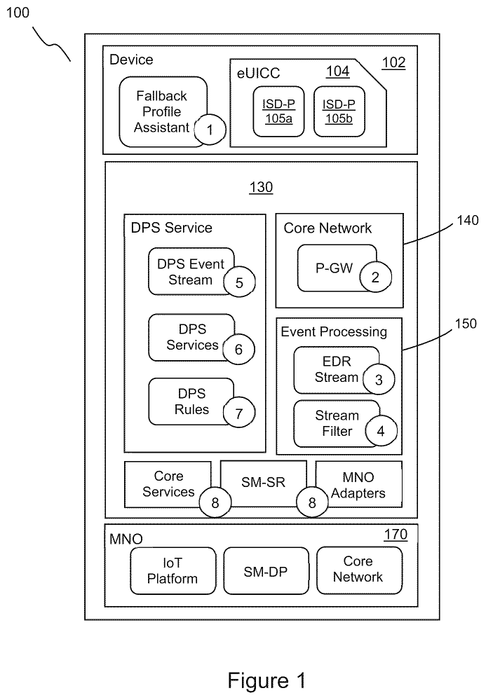

A system 100 according to an aspect of the invention is shown in FIG. 1. The system comprises a mobile device 102, a server 130 and a Mobile Network Operator, MNO, 170. In preferred embodiments the mobile device 102 is located in a network-enabled vehicle such as a car, truck, drone, plane or an agricultural vehicle such as a combine harvester or tractor. The mobile device 102 may be a network access device, NAD, or modem that allows internet connections to be made between vehicles and networks (e.g. mobile communication networks such as 3G, 4G or 5G networks). The mobile device 102 is able to physically cross borders such as international borders between countries and/or network coverage borders between coverage areas provided by different MNOs.

As will be explained in further detail below, the methods, apparatus and systems disclose herein allow mobile device 102 to maintain network connectivity even when it has moved across a border, such as an international border between two or more countries, states or territories and/or borders between regions of network coverage provided by different MNOs, for example within a single country, state or territory.

Mobile device 102 comprises an embedded Subscriber Identity Module, eSIM, 104. The eSIM 104 is an embedded Universal Integrated Circuit Card, eUICC, particularly a machine-to-machine, M2M, eUICC comprising at least one profile 105. Different types of eSIMs are available and in the context of the present teaching it is not intended to limit to any one specific type. For example, the eSIM 104 may be a Consumer (SGP.22) or Internet of Things, IoT, (SGP.32) eSIM. In this example, the eSIM 104 comprises a bootstrap profile 105a and a home profile 105b.

The home profile 105b comprises an IMSI which allows connections to be made to the network provided by MNO 170. MNO 170 can identify and grant network access to the mobile device 102 by inspecting the IMSI of the home profile 105b. Where a manufacturer is aware of the geographical location where the mobile device 102 is to be deployed, the home profile 105b can be installed on the eUICC 104 during manufacture of the eSIM 104 and/or mobile device 102. Alternatively, if the geographical region where the mobile device 102 is to be deployed is not known then the eSIM 104 may be provisioned with a suitable home profile 105b after manufacture of the eSIM 104 and/or mobile device 102.

MNO 170 can also identify and grant network access to the mobile device 102 by inspecting the IMSI of the bootstrap profile 105b. The bootstrap profile 105a, which may also be referred to as a provisioning profile, may be pre-installed on the eUICC 104 to allow the mobile device 102 to connect to any available network anywhere the world. In other words, the bootstrap profile 105a is a type of ‘global’ profile which is not limited to a single network and can allow access to networks provided by a range of MNOs across the world. Again, the eSIM 104 may be provisioned with a suitable bootstrap profile 105a after manufacture of the eSIM 104 and/or mobile device 102.

The mobile device 102 further comprises a processor and memory (not shown). The memory comprises computing instructions configured to cause the mobile device 102 to carry out the methods described herein.

The mobile device 102 comprises a fallback profile assistant 1 which is hosted in the device 102. The fallback profile assistant 1 is an on-board application which can detect loss of connectivity at the mobile device 102. The mobile device 102 may lose connectivity to a network when using a particular profile. When this happens, the fallback profile assistant 1 can be used to ensure that the eUICC 104 falls back to the appropriate profile, such as the bootstrap profile 105a, in response to the loss of connectivity.

Many mobile devices contain in-built/default eUICC fallback mechanisms which rely on receipt of specific network rejection codes at the respective mobile device. Real-world testing highlights the limitations of such in-built/default eUICC fallback mechanisms, especially when network connections have been interrupted or lost. Furthermore, the configuration of in-built/default eUICC fallback mechanisms cannot be modified without additional OS development by the manufacturer of the eUICC. The fallback profile assistant 1 overcomes these problems.

The fallback profile assistant 1 detects loss of connectivity by polling the current network registration status, using Attention, AT, commands (e.g. AT+CREG:—Status NOT IN (1,5), which is polled for e.g. 5 minutes). After a continual period (e.g. 5 minutes) of no network registration, the fallback profile assistant 1 triggers a Local Swap/Fallback Request to the eUICC 104 using AT commands (e.g. AT+STKENV=211,124). The fallback request may be triggered by the mobile device 102. For example, in cases where the mobile device 102 completely loses connection to the network, it will not be possible for that mobile device to receive e.g. fallback requests from remote resources. Therefore in such cases the fallback request can be triggered locally. In response to the fallback request, the eUICC 104 switches to a particular profile (e.g. the bootstrap profile 105a) which then allows the mobile device 102 to connect to a wide range of networks provided by various MNOs.

FIG. 1 also shows an example server 130. It will be appreciated that the server 130 may comprise a plurality of servers distributed over a network. The server 130 comprises a Device Provisioning Service, DPS, 132. The DPS service 132 comprises a DPS event stream 5, a DPS Service module 6 and DPS Rules 7. The DPS event stream 5 ingests DPS-relevant events only. The DPS Service 6 consumes the DPS events and compares against its configured rules 7 to identify the use of non-preferred IMSIs and determine the preferred IMSI. The list of configured rules defines the preferred IMSI per country and the roaming tolerance thresholds. The server 130 comprises a core network, CN, 140 including a packet gateway 2, P-GW. The P-GW 2 publishes various session Event Data Records, EDRs, in Real-Time. The server 130 comprises an event processing module 150. The event processing module 150 comprises an EDR event stream 3 and a stream filter 4. The EDR event stream 3, published by the P-GW 2, is ingested and processed. The EDR Event Stream 3 is queried, in-stream, and DPS-relevant events are identified and published downstream at the DPS Event Stream 5. The server 130 comprises core services, SM-SR and MNO Adaptors 8. When a profile switch is required, core services may be invoked to download/enable the preferred profile through the MNO systems.

FIG. 1 also shows an example MNO 170. The MNO 170 comprises an IoT Platform, SM-DP and a Core Network. Networks provided by MNO 170 may include LTE networks, GSM networks, 3G networks, 5G networks, and the like.

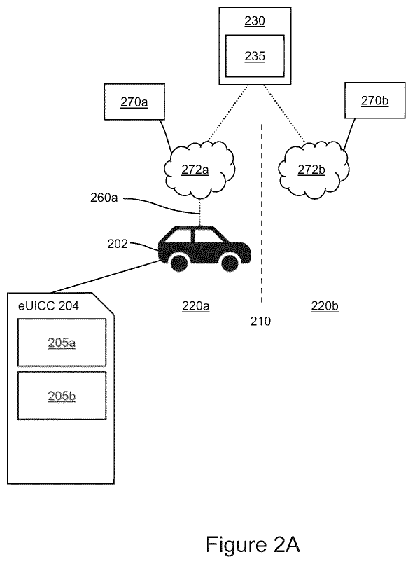

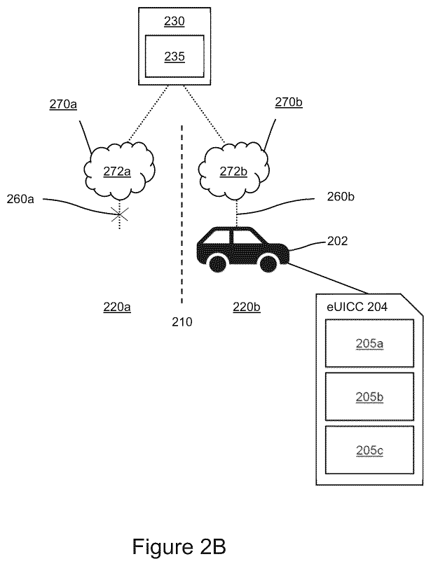

FIGS. 2A and 2B show an example mobile device 202 before and after crossing a border 210, respectively. In preferred embodiments the mobile device 202 is a NAD or modem located within a network-enabled vehicle such as a car, truck, drone, plane or an agricultural vehicle such as a combine harvester or a tractor. The mobile device 202 is able to physically cross borders such as international borders between countries and/or network coverage borders between coverage areas provided by different MNOs.

In this example, the border 210 is a border which defines a separation of network coverage provided by separate MNOs i.e. a border between a first territory 220a in which a first MNO 270a provides network coverage and a second territory 220b in which a second MNO 270b provides network coverage. Networks provided by the first and second MNOs 270 may include LTE networks, GSM networks, 3G networks, 5G networks, and the like. Border 210 may correspond to an international border between two countries, territories or states, a plurality of borders between multiple countries, territories or states, or a network services border within a single country, territory or state. One or both of the first territory 220a and the second territory 220b may correspond to multiple countries, territories or states in which groups of MNOs have roaming agreements.

The mobile device 202 shown in FIGS. 2A and 2B is similar to the mobile device 102 shown in FIG. 1 and described above. In particular, the mobile device comprises an eSIM 204 and a fallback profile assistant similar to those described previously. In examples eSIM 204 is an M2M eUICC, and may be a Consumer (SGP.22) or IoT (SGP.32) eSIM.

The server 230 shown in FIGS. 2A and 2B is similar to the server 130 shown in FIG. 1 and described above. In this example the server 230 comprises a connection manager 235. As is explained in further detail below, the connection manager 235 is configured for monitoring profile usage at the mobile device 202.

In FIG. 2A mobile device 202 is in the first territory 220a. The eSIM 204 of the mobile device 202 holds a bootstrap profile 205a and a home profile 205b. In FIG. 2A the mobile device 202 is in a configuration in which the bootstrap profile 205a is disabled and the home profile 205b is enabled. The mobile device has a network connection 260a to the network 272a of the first MNO 270a. The network connection 260a allows the transfer of data to and from the mobile device 202. For example, data such as streaming data, instructions, updates and/or notifications can be transferred between the mobile device 202 and the server 230 via the network connection 260a to network 272a.

In FIG. 2A the mobile device 202 is connected to the network 272a of the first MNO 270a using its enabled home profile 205b. The home profile 205b comprises an IMSI which allows connections to be made to the network 272a of the first MNO 270a. It will be appreciated that the first MNO 270a could also identify and grant network access to the mobile device 202 when the mobile device 202 falls back to the bootstrap profile 205a, by inspecting the IMSI of the bootstrap profile 205a when the bootstrap profile 205a has been enabled. However, while the mobile device 202 remains within the geographic range of the first MNO 270a, it is preferred that the mobile device 202 stays connected to the network of the first MNO 270a using the home profile 205b.

In FIG. 2B mobile device 202 has moved into the second territory 220b by crossing border 210. It will be noted that eUICC 204 of mobile device 202 has also gained an alternative profile 205c (methods of how this can be achieved are explained in further detail below).

As noted above, and as will be conventionally understood, the border 210 defines a separation of network coverage provided by the first MNO 270a and the second MNO 270b. The second territory 220b is outside the geographic range of coverage provided by the first MNO 270a. This means that, once the mobile device 202 is in the second territory 220b it is no longer able to maintain the network connection 260a to the network 272a provided by the first MNO 270a.

In the present example, network coverage can be provided in the second territory 220b by the second MNO 270b. To ensure that the mobile device 202 can send and receive data in the second territory 220b, for example to and from the server 230, then a network connection 260b must be made to the network of the second MNO 270b.

In the second territory 220b the mobile device 202 can connect to the new local network provided by the second MNO 270b using one of the following options:
(i) remaining on the home profile 205b and using an IMSI of the home profile 205b to roam on the new local network;
(ii) enabling the bootstrap profile 205a and using an IMSI of the bootstrap profile 205a to roam on the new local network; or
(iii) enabling an alternative profile 205c which allows connections to be made to the new local network 272b (e.g. a profile having an IMSI belonging to/provided by the second MNO 270b, or another MNO having a roaming agreement with the second MNO 270b) and using an IMSI of the alternative profile 205c to connect to the new local network.

Each option has certain limitations. Option (i) is not available when there is no roaming agreement between the first MNO 270a and the second MNO 270b. This is typically the case when the first and second territories are non-neighbouring and there are large distances between them. Option (ii) is often territory-dependent and time-limited, since many MNOs only allow roaming devices to connect to their network for a limited amount of time. Option (iii) relies on the eUICC of the device having an alternative profile which can allow connections to be made to the new local network 272b.

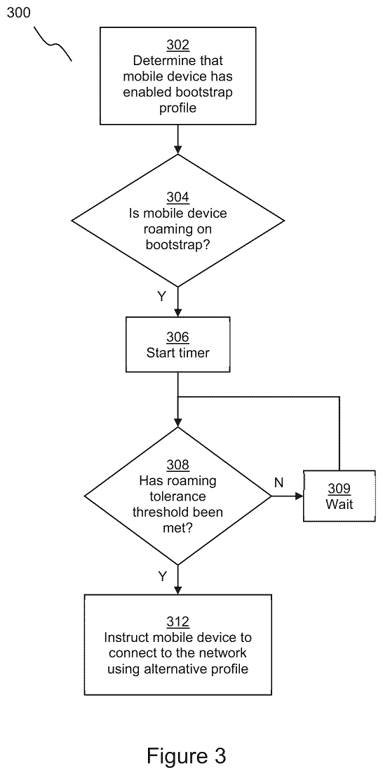

The methods described below in relation to FIGS. 3 to 8, 10, and 11 allow dynamic switching between profiles in order to maintain connectivity at a mobile device is in a particular territory, for example after said mobile device has crossed a border such as a network coverage border. As will be understood, the methods presented herein can make varying use of options (i) to (iii) to effectively manage network connections at a mobile device.

FIG. 3 discloses an example method 300 according to an aspect of the invention. The method 300 can be used to manage network connections at a mobile device configured for communication with a connection manager. The mobile device could be either of the mobile devices 102 and 202 disclosed in FIGS. 1 and 2, and the connection manager can correspond to computer instructions stored on either of the servers 130 and 230 disclosed in FIGS. 1 and 2. For brevity, the example method 300 will be explained with reference to the mobile device 202 and server 230 shown in FIGS. 2A and 2B.

Method 300 begins at step 302 in which the connection manager 235 (located on server 230) determines that the mobile device 202 has enabled the bootstrap profile 205a. The mobile device enables the bootstrap profile 205a in response to crossing the border 210. In particular, the mobile device 202 comprises a fallback profile assistant (as described above) which causes the eUICC 104 to enable the bootstrap profile 105a in response to a loss of connectivity to home network 272a after crossing border 210.

The connection manager 235 (located on server 230) determines that the mobile device 202 has enabled the bootstrap profile 205a by receiving a message from and/or polling the fallback profile assistant which can communicate the current status of the eSIM 204 and/or network status of mobile device 202 to the connection manager 235. As will be appreciated, in this example the connection manager 235 can only detect that the mobile device 202 has enabled the bootstrap profile 205a after the mobile device has been able to connect to the new local network 272b using the IMSI of the bootstrap profile 205a. Therefore there may be a short delay between the time when the mobile device 202 falls back to the bootstrap profile 205a and the time when the connection manager 235 actually detects that the bootstrap profile 205a has been enabled.

At step 304, the connection manager 235 determines whether the mobile device is currently roaming on the bootstrap profile 205a. In particular, the connection manager 235 determines whether a roaming event has taken place at the mobile device 202 such that the mobile device 202 is connected to the network 272b of the second MNO 270b using an IMSI of the bootstrap profile 205a. The connection manager 235 makes this determination by inspecting information received from the fallback profile assistant i.e. the current status of the eSIM 204 and/or network status of mobile device 202. If the connection manager identifies that the mobile device has connected to the network of the second MNO 270b using an IMSI of the bootstrap profile 205a (‘Y’ branch from box 304 in FIG. 3), then the method proceeds to step 306.

In step 306 the connection manager 235 starts a timer. The timer is used to measure the amount of time that the mobile device 202 has been known to be connected to the network 272b of the second MNO 270b using the IMSI of the bootstrap profile 205a.

In step 308 the connection manager 235 determines whether a connectivity tolerance threshold has been met. The connectivity tolerance threshold corresponds to a predetermined maximum usage, by the mobile device 202, of the IMSI of the bootstrap profile 205a to connect to the network 272b. The connectivity tolerance threshold corresponds to an amount of time that the mobile device 202 is allowed to be connected to the network 272b of the second MNO 272b using the bootstrap profile 205a. The connection manager 235 stores and/or is able to access various connectivity tolerance thresholds defined for specific combinations of profiles and MNOs.

In the present example, the connectivity tolerance threshold used in step 308 is a roaming tolerance threshold defined for use of the bootstrap profile 205a on the network 272b of the second MNO 270b. The connectivity tolerance threshold is met when the mobile device 202 has been continuously connected to the network 272b of the second MNO 270b using the IMSI of the bootstrap profile 205a for a predetermined period of time, such as one or more days, weeks, months or years. The connection manager 235 determines whether or not the roaming tolerance threshold has been met by comparing the roaming tolerance threshold with the timer that was started in step 306.

In the present example, the second MNO 270b allows roaming profiles to be connected to the network 272b for up to 90 days. Once a mobile device has been connected to the network 272b using a roaming profile for the maximum 90 days, then the connection to the network will be refused. In the present example, the roaming tolerance threshold is set to 45 days (i.e. less than the maximum allowed roaming time permitted by the second MNO 270b) so that once the connection manager 235 determines that the mobile device 202 has been connected to the network 272b of the second MNO 270b using the bootstrap profile 205a for 45 days, the connection manager 235 will instruct the mobile device 202 to use a different profile, such as a local profile for the network of the second MNO 270b. This ensures that the mobile device 202 will not reach the maximum roaming time and therefore will not be prevented from using the network 272b.

As will be appreciated, the roaming tolerance threshold can be adjusted for each MNO/profile combination. The roaming tolerance threshold may be set to be a different number of days, weeks, months etc. according to how long a particular MNO allows roaming profiles to use its network, and/or how long a mobile device should be allowed to use a roaming profile before switching to e.g. a local profile. By setting the roaming tolerance threshold to e.g. 45 days, the connection manager 235 ensures that the mobile device 202 will remain on the bootstrap profile 205c for some time after crossing a border. This can be useful where the mobile device 202 crosses multiple territories in a short period and it would not be practical or efficient to obtain local profiles for each territory. Conversely, the roaming tolerance threshold may be set to zero e.g. when it is determined that a mobile device should not be allowed to roam on the bootstrap profile when using the network of a particular MNO.

Roaming tolerance thresholds for multiple MNO/profile combination may be stored in the connection manager 235, in a local file on the same server as the connection manager 235 and/or remotely from the connection manager 235.

Returning to FIG. 3, if in step 308 it is determined that the connectivity tolerance threshold has not been met (‘N’ branch from box 308 in FIG. 3), then the method 300 proceeds to step 309. In step 309 the connection manager 235 waits for a predetermined amount of time, for example 12 hours, before returning to the determination at step 308.

If in step 308 it is determined that the connectivity tolerance threshold has been met (‘Y’ branch from box 308 in FIG. 3), then the method 300 proceeds to step 312. In step 312 the connection manager 235 instructs the mobile device 202 to connect to the network 272b using the alternative profile 205c. In particular, the connection manager 235 sends an instruction to the mobile device 202 to connect to the network 272b using an IMSI of the alternative profile 205c. In response, the mobile device 202 enables the alternative profile 205c and connects to the network 272b using an IMSI of the alternative profile 205c.

As will be appreciated the example method 300 assumes that, when in the second territory 220b, the eUICC 204 already contains an alternative profile 205c suitable for connecting to the network 272b provided by the second MNO 270b. In cases where the mobile device 202 crosses border 210 and reaches the second territory 220b without an alternative profile 205c stored in the eUICC 204 method 300 cannot be used to effectively maintain network connections at the mobile device 202.

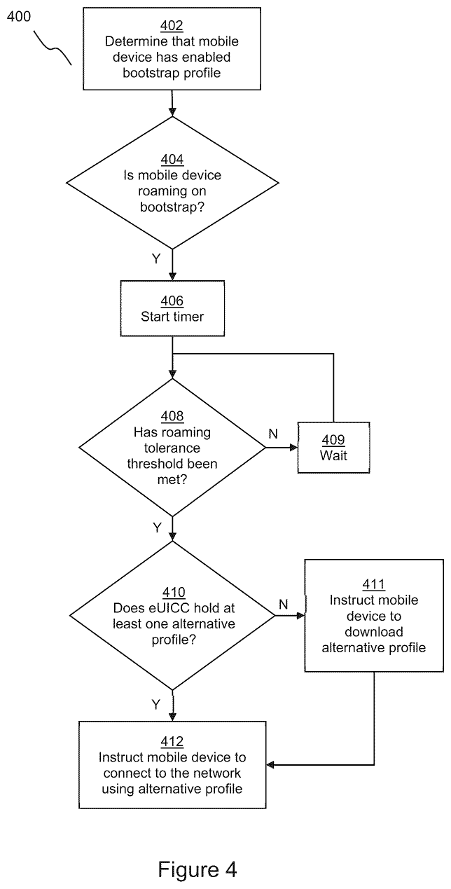

FIG. 4 discloses an example method 400 according to an aspect of the invention. The method 400 can be used to manage network connections at a mobile device, such as the mobile devices 102 and 202 disclosed in FIGS. 1 and 2. In particular, the method 400 can be used to manage network connections at a mobile device which enters a territory with or without a profile suitable for connecting to a new local network provided by a new local MNO in that territory. Many steps of the method 400 are similar to the method 300 shown in FIG. 3, with similar numerals (e.g. 302, 402) denoting similar steps. The method 400 is distinguished from the method 300 by steps 410 and 411.

In step 410, after determining that the roaming tolerance threshold has been met in step 408 (‘Y’ branch from box 408 in FIG. 4) the connection manager 235 determines whether the eUICC 204 of the mobile device 202 has at least one alternative profile 205c suitable for connecting to the network 272b provided by the second MNO 270b.

If in step 410 it is determined that the eUICC 204 of the mobile device 202 does not have at least one alternative profile 205c suitable for connecting to the network 272b provided by the second MNO 270b (‘N’ branch from box 410 in FIG. 4), then the method proceeds to step 411. In step 411 the connection manager 235 instructs the mobile device 202 to download the alternative profile 205c. For example, the mobile device can download the alternative profile from the connection manager 235 or other suitable source using the existing connection (i.e. the roaming connection on the bootstrap profile 205a). After instructing the mobile device 202 to download the alternative profile 205c, in step 412 the connection manager 235 instructs the mobile device to connect to the network 272b (i.e. the new local network provided by the second MNO 270b) using the alternative profile 205c. In particular, the connection manager 235 sends an instruction to the mobile device 202 to connect to the network 272b using an IMSI of the alternative profile 205c.

If in step 410 it is determined that the eUICC 204 of the mobile device 202 does already have at least one alternative profile 205c suitable for connecting to the network 272b provided by the second MNO 270b (‘Y’ branch from box 410 in FIG. 4), then the method 400 proceeds to step 412 (described above).

As will be appreciated, the present disclosure can be applied to managing dynamic switching between profiles more generally, for example when the mobile device 202 is connected to a network using a non-optimal profile.

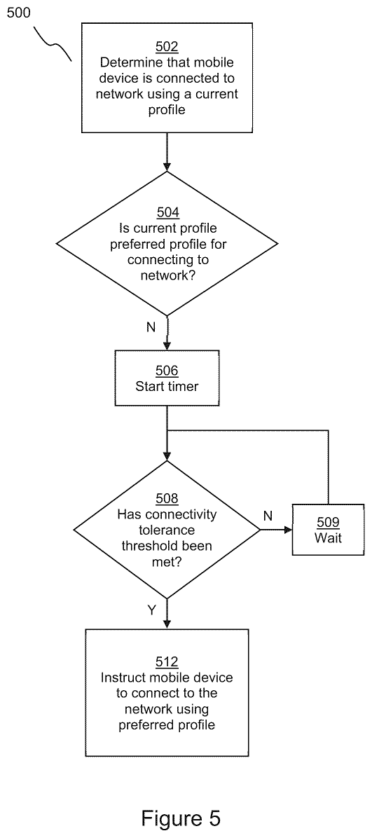

FIG. 5 discloses an example method 500 according to an aspect of the invention. The method 500 can be used to manage network connections at a mobile device configured for communication with a connection manager. The mobile device could be either of the mobile devices 102 and 202 disclosed in FIGS. 1 and 2, and the connection manager could correspond to computer instructions stored on either of the servers 130 and 230 disclosed in FIGS. 1 and 2. For brevity, the example method 500 will be explained with reference to the mobile device 202 and server 230 shown in FIGS. 2A and 2B.

Method 500 begins at step 502 when the connection manager 235 (located on server 230) determines that the mobile device 202 is connected to a network, for example the network provided by the second MNO 270b, using a current profile. In this example, the current profile is the alternative profile 205c.

At step 504, the connection manager 235 determines whether the current profile being used to connect to the network is the preferred profile for the mobile device 202 to connect to that network. The connection manager 235 makes this determination by inspecting information received from the mobile device 202. For example, the connection manager 235 may poll the mobile device 202 for information. The information received from the mobile device 202 includes the current IMSI being used by the mobile device 202, details of the network being used by the mobile device 202 and optionally country information for that network. The connection manager 235 uses the received information to determine whether the current profile being used (i.e. the profile corresponding to the current IMSI being used) is the preferred profile. The connection manager 235 makes a rules-based determination of whether the current profile being used is the preferred profile. For example, the connection manager 235 may compare the current profile with the preferred profile defined in a lookup table for that network. The lookup table may be stored at the connection manager 235.

If in step 504 it is determined that the current profile being used to connect to the network is not the preferred profile (‘N’ branch from box 504 in FIG. 5), then the method 500 proceeds to step 506. In step 506 the connection manager 235 starts a timer. The timer is used to measure the amount of time that the mobile device 202 has been known to be connected to the network 272b of the second MNO 270b using the IMSI of the non-preferred profile (i.e. the alternative profile).

In step 508 the connection manager 235 determines whether a connectivity tolerance threshold has been met. The connectivity tolerance threshold corresponds to a predetermined maximum usage, by the mobile device 202, of the IMSI of the non-preferred profile to connect to the network 272b The connectivity tolerance threshold corresponds to an amount of time that the mobile device 202 is allowed to be connected to the network 272b of the second MNO 272b using the non-preferred profile. The connection manager 235 stores and/or is able to access various connectivity tolerance thresholds defined for specific combinations of profiles and MNOs.

In the present example, the connectivity tolerance threshold used in step 508 is defined for use of any profile other than the bootstrap profile 205a on the network 272b of the second MNO 270b. The connectivity tolerance threshold is met when the mobile device 202 has been continuously connected to the network 272b of the second MNO 270b using the IMSI of any profile other than the bootstrap profile 205a for a predetermined period of time, such as one or more days, weeks, months or years. The connection manager 235 determines whether or not the connectivity tolerance threshold has been met by comparing the roaming connectivity threshold with the timer that was started in step 506.

In the present example, the connectivity tolerance threshold has been set to 1 hour. This may be because the charges associated with using the local profile 205c to connect to the network 272b of the second MNO 270b are more expensive than using the bootstrap profile 205a, and/or because better network coverage will be provided by the bootstrap profile 205a. Setting the connectivity tolerance threshold to 1 hour reduces the probability of repeated switching when e.g. the device is connected to network 272b for only a short period.

If in step 508 it is determined that the connectivity tolerance threshold has not been met (‘N’ branch from box 508 in FIG. 5), then the method 500 proceeds to step 509. In step 509 the connection manager waits for a predetermined amount of time, for example 1 minute, before returning to the start of step 508.

If in step 508 it is determined that the connectivity tolerance threshold has been met (‘Y’ branch from box 508 in FIG. 5), then the method 500 proceeds to step 512. In step 512 the connection manager 235 instructs the mobile device to connect to the network (i.e. the new local network provided by the second MNO 270b) using the preferred profile. The preferred profile may be the bootstrap profile 205a. In particular, the connection manager sends an instruction to the mobile device 202 to connect to the network using an IMSI of the preferred profile. In response, the mobile device 202 enables the preferred profile and connects to the network using an IMSI of the preferred profile.

As will be appreciated, method 500 may be augmented with steps similar to steps 410 and 411 described above, i.e. the method 500 may additionally include determining whether or not the eUICC 204 of the mobile device 202 holds the preferred profile and, if not, instructing the mobile device 202 to download the alternative profile.

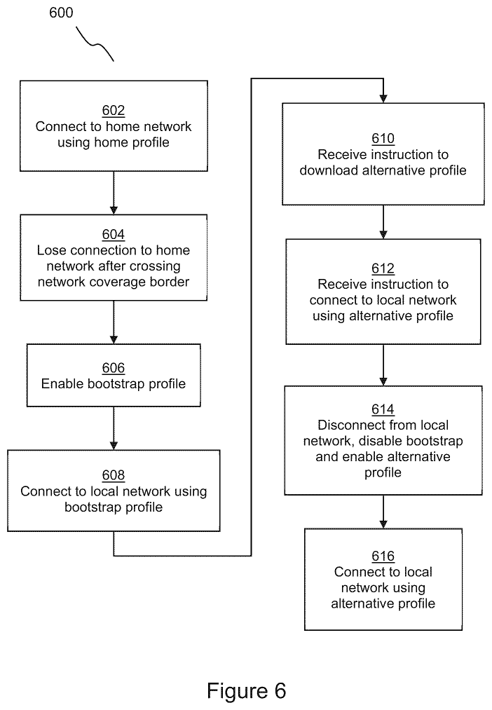

FIG. 6 discloses an example method 600 according to an aspect of the invention. The method 600 can be used to manage network connections at a mobile device configured for communication with a connection manager. The mobile device could be either of the mobile devices 102 and 202 disclosed in FIGS. 1 and 2, and the connection manager could correspond to computer instructions stored on either of the servers 130 and 230 disclosed in FIGS. 1 and 2. For brevity, the example method 600 will be explained with reference to the mobile device 202 and server 230 shown in FIGS. 2A and 2B.

Method 600 begins at step 602 in which the mobile device 202 connects to its home network using the home profile 205b stored on the eUICC 204 (FIG. 2A). At step 604 the mobile device 202 loses connection to the home network after crossing border 210 (FIG. 2B). Once the border 210 has been crossed, the mobile device 202 will be out of the range of the home network 272a. At step 606 the mobile device 202 enables the bootstrap profile 205a. In particular, the fallback profile assistant of mobile device 202 causes the eUICC 104 to enable the bootstrap profile 105a in response to a loss of connectivity to home network 272a after crossing border 210. This allows the mobile device 202 to connect to the new local network 272b in the second territory 220b. At step 608, the mobile device 202 connects to the new local network using the bootstrap profile 205a. In this example, the mobile device 202 connects to the network of the second MNO 270b using an IMSI of the bootstrap profile 205a.

In step 610 the mobile device 202 receives an instruction to download an alternative profile 205c to the eUICC 204. This instruction is sent from the connection manager 235 to the mobile device 202 when the eUICC 204 does not hold an alternative/preferred profile suitable for connecting to the network of the second MNO 270b. It will be appreciated that step 610 is optional: if the mobile device 202 already holds an alternative/preferred profile suitable for connecting to the network of the second MNO 270b then no instruction will need to be sent. In response to the received instruction, the mobile device 202 downloads the alternative profile. As is explained above, connection manager 235 is able to identify a suitable alternative profile suitable for connecting to the network of the second MNO 270b.

In step 612 the mobile device 202 receives an instruction to connect to the new local network 272b using the alternative profile 205c. This instruction is sent from the connection manager 235 to the mobile device 202 when the connection manager 235 determines that a connectivity tolerance threshold, such as a roaming tolerance threshold, has been met. In response to the received instruction, the method 600 proceeds to step 614 in which the mobile device disconnects from the local network 272b, disables the bootstrap profile 205a and enables the alternative profile 205c. At step 616 the mobile device 202 connects to the local network 272b (the network of the second MNO 270b) using the alternative profile 205c.

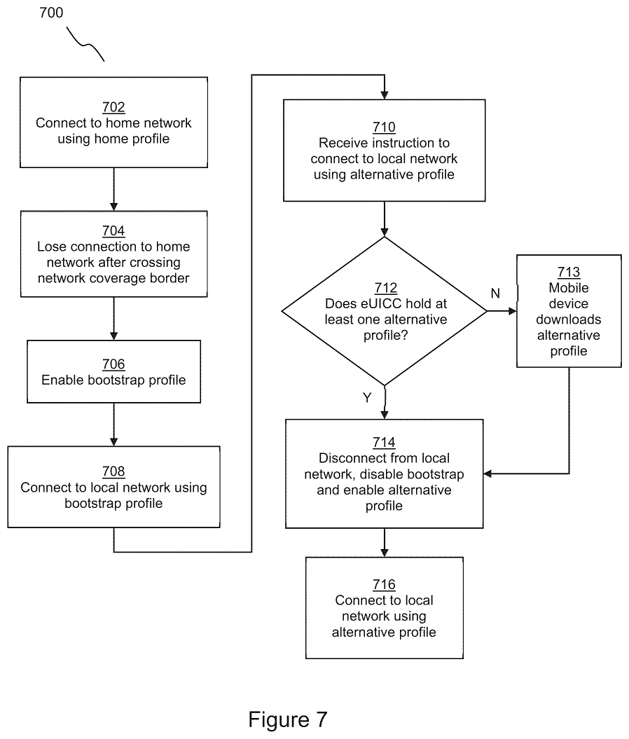

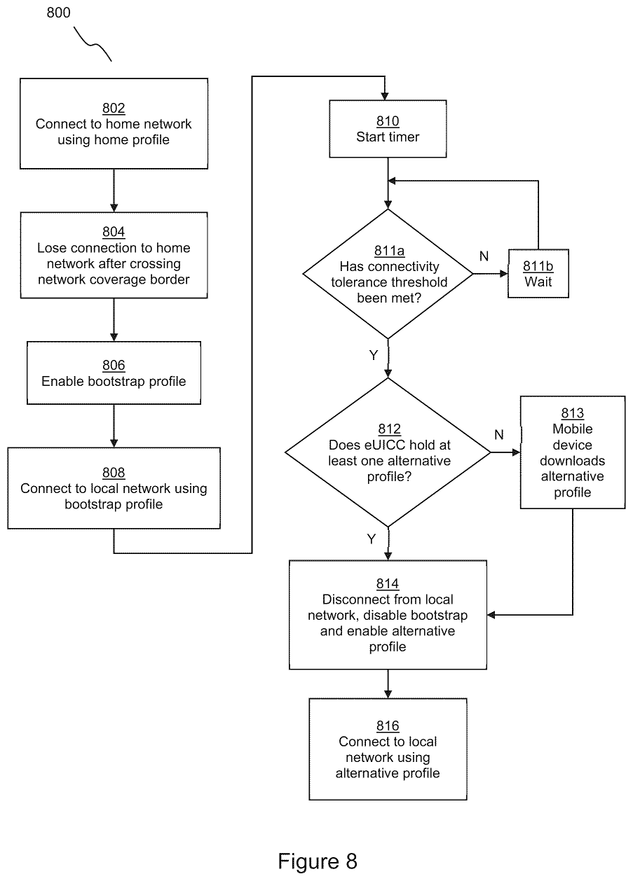

As will be appreciated, the methods 300, 400, 500 and 600 relate to managing network connections at a mobile device by a connection manager. In these examples the connection manager can be implemented in a server which is remote from the mobile device. However, in optional embodiments the connection manager may be implemented locally on the mobile device. In further optional embodiments, one or more steps of the above methods may be carried out at the mobile device, rather than at the (remote) connection manager. FIG. 7 discloses an example method 700 where some steps are carried out at the mobile device. FIG. 8 discloses an example method 800 where all steps of the previous methods are carried out at the mobile device.

FIG. 7 discloses an example method 700 according to an aspect of the invention. The method 700 can be used to manage network connections at a mobile device, such as the mobile devices 102 and 202 disclosed in FIGS. 1 and 2. Many steps of the method 700 are similar to the method 600 shown in FIG. 6, with similar numerals (e.g. 602, 702) denoting similar steps. The method 700 is distinguished from the method 600 by steps 710, 712 and 713.

In step 710 the mobile device 202 receives an instruction to connect to the new local network 272b using an alternative profile 205c. This instruction is sent from the connection manager 235 to the mobile device 202 when the connection manager determines that a connectivity tolerance threshold, such as a roaming tolerance threshold, has been met. In response to the received instruction, the method 700 proceeds to step 712 in which the mobile device 202 determines whether the eUICC 204 has at least one alternative profile, particularly an alternative profile suitable for connecting to the network 272b of the second MNO 270b.

If in step 712 it is determined that the eUICC 204 of the mobile device 202 does not have at least one alternative profile 205c suitable for connecting to the network 272b provided by the second MNO 270b (‘N’ branch from box 712 in FIG. 7), then the method proceeds to step 713. In step 713 the mobile device 202 downloads the alternative profile 205c. For example, the mobile device 202 can download the alternative profile 205c from the connection manager 235 or other suitable source using the existing connection (e.g. the roaming connection on the bootstrap profile 205a). After downloading the alternative profile 205c, the method proceeds to step 714, which is similar to step 614 explained previously.

If in step 712 it is determined that the eUICC 204 of the mobile device 202 does have at least one alternative profile 205c suitable for connecting to the network 272b provided by the second MNO 270b (‘Y’ branch from box 712 in FIG. 7), then the method proceeds to step 714, which again is similar to step 614 explained previously.

The advantage of method 700 over method 600 is that the responsibility for determining whether the mobile device needs to download an alternative profile is offloaded from the connection manager 235 to the mobile device 202. In some embodiments it may be beneficial to offload all steps carried out by the connection manager 235 to the mobile device 202.

FIG. 8 discloses an example method 800 according to an aspect of the invention. The method 800 can be used to manage network connections at a mobile device, such as the mobile devices 102 and 202 disclosed in FIGS. 1 and 2. Many steps of the method 800 are similar to the method 700 shown in FIG. 7, with similar numerals (e.g. 702, 802) denoting similar steps. The method 800 is distinguished from the method 700 by steps 810, 811a and 811b.

In step 810 the mobile device 202 starts a timer in response to connecting to a new local network (i.e. the network 272b of the second MNO 270b) using the bootstrap profile 205a. The timer is used to measure the amount of time that the mobile device 202 has been connected to the network of the second MNO 270b using the IMSI of the bootstrap profile 205a.

In step 811a the mobile device 202 determines whether a connectivity tolerance threshold has been met. The connectivity tolerance threshold is similar to one or more of the connectivity tolerance thresholds described above in relation to the previous methods. The mobile device 202 determines whether or not the roaming tolerance threshold has been met by comparing the connectivity tolerance threshold with the timer that was started in step 810.

If in step 811a it is determined that the connectivity tolerance threshold has not been met (‘N’ branch from box 811a in FIG. 8), then the method 800 proceeds to step 811b. In step 811b the mobile device 202 waits for a predetermined amount of time, for example 1 minute or 12 hours, before returning to the start of step 811a.

If in step 308 it is determined that the connectivity tolerance threshold has been met (‘Y’ branch from box 811a in FIG. 8), then the method 800 proceeds to steps 812, which is similar to step 712 explained previously.

The advantage of method 800 over e.g. method 700 is that the determination of whether the mobile device has met a connectivity threshold is carried out at the mobile device 202, which may allow a more accurate determination of the amount of time that the mobile device has been connected to the network of the second MNO 270b on the bootstrap profile 205a. Furthermore, making the determination of whether the mobile device 202 has met a connectivity threshold locally at the mobile device 202 means that this method step does not rely on an over-the-air connection to a remote resource, such as the connection manager 235. This is particularly useful in areas of poor coverage where it may be more appropriate to rely on local computing resources rather than remote resources only accessible via unreliable or weak connections to the network.

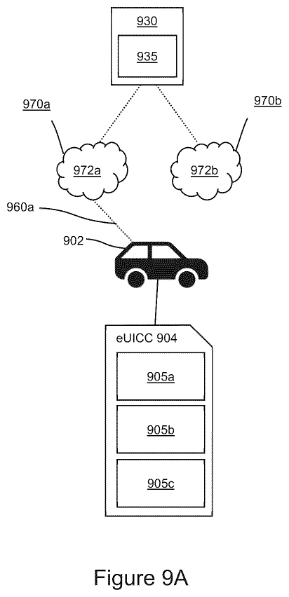

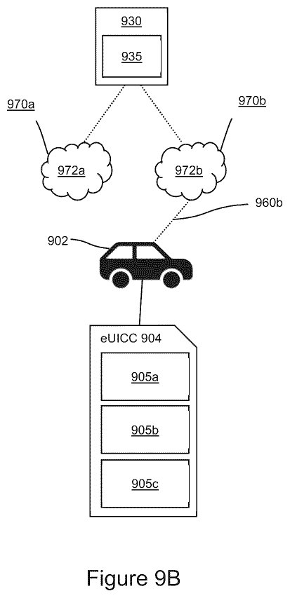

FIGS. 9A and 9B show an example mobile device 902 in accordance with the present teaching. The mobile device 902 is similar to the mobile devices 102 and 202 described above, and similar reference numerals will be used to describe comparable components. In particular, the mobile device 902 comprises an eSIM 904 and a fallback profile assistant similar to those described previously. In examples eSIM 904 is an M2M eUICC and may be a Consumer (SGP.22) or IoT (SGP.32) eSIM. The eSIM 904 of the mobile device 902 holds a bootstrap profile 905a, a home profile 905b and an alternative profile 905c.

The server 930 shown in FIGS. 9A and 9B is similar to the servers 130 and 230 shown in FIGS. 1 and 2 and described above. In this example, the server 930 comprises a connection manager 935 which is similar to the connection manager 235 described above. As is explained in further detail below, the connection manager 935 is configured for monitoring profile usage at the mobile device 902. In alternative embodiments, the connection manager 935 may be located on the mobile device 902 itself rather than on the server 930.

In the example shown in FIGS. 9A and 9B, the mobile device 902 is in a location where network coverage can be provided by two separate MNOs i.e. a region in which a first MNO 970a provides network coverage and a second MNO 970b also provides network coverage. Networks provided by the first and second MNOs 970 are similar to the networks provided by MNOs 270 described above.

In the present example, network connectivity services can be provided to the mobile device 902 by either of the first MNO 970a or by the second MNO 970b. To ensure that the mobile device 902 can send and receive data, for example to and from the server 930, a network connection must be made to the network 972a of the first MNO 970a or to the network 972b of the second MNO 970b. In further examples, further networks provided by further MNOs may also be available at the location of the mobile device 902.

In embodiments, the mobile device 902 may be instructed to use a particular network and profile combination that will provide the best Quality of Experience (QoE). By QoE it is meant the quality of a connection experienced at a mobile device and is determined by reference to one or more data sets. For example, QoE data sets may include at least one of: Received Signal Strength Indicator (RSSI) data, Reference Signal Received Power (RSRP) data, Reference Signal Received Quality (RSRQ) data, Signal-to-Noise Ratio (SNR) data, Signal to Interference and Noise Ratio (SINR) data, frequency band data, Mobile Country Code (MCC) data, Mobile Network Code (MNC) data, cell data and location data. Such data sets may be further enriched with further statistical data such as changes of RAT, dropped calls, dropped data sessions, data throughput and/or network rejections. Additionally, recent historical network experience for that particular network location may also be included in the QoE data.

QoE data may be routinely stored or cached at the mobile device 902 during operation of the mobile device 902. The mobile device 902 may be configured to report QoE data (which includes e.g. RSSI data, RSRP data, RSRQ data, SNR data SINR data, SINR data, frequency band data, MCC data, MNC data, changes of RAT, number of dropped calls, number of dropped data sessions, data throughput and/or number of network rejections) to a central facility, such as server 930 and/or connection manager 935. Such a central facility can be configured to collect QoE data from a plurality of mobile devices or sources, allowing insights to be gained regarding historical QoE coverage.

QOS (Quality of Service) is generally configured on the network while QoE is measured on the connected device itself. To determine poor QoE, radio statistics (e.g. RSSI data, RSRP data, RSRQ data, SNR data SINR data, SINR data, frequency band data, MCC data, MNC data, changes of RAT, number of dropped calls, number of dropped data sessions, data throughput and/or number of network rejections) are monitored, for example at the central facility. When determining which network will provide the best QoE at a particular network location, a combination of radio statistics and recent historical experience for that network location can be used.

FIG. 9A shows the mobile device 902 having a network connection to a first or initial network 972b. The mobile device 902 may be, or be located in, a network-enabled vehicle such as a car, truck, drone or plane. For example, the mobile device 902 may be any suitable mobile computing device, such as a NAD or modem locatable in a vehicle. Alternatively, the mobile device 902 may be hardware components of the vehicle which allow the vehicle to connect to a network, such as a cellular or radio access network.

In FIG. 9A the mobile device 902 is in a first configuration in which the home profile 905b is enabled and the bootstrap profile 905a and the alternative profile 905c are disabled. The mobile device 902 has a network connection 960a to the network 972a of the first MNO 970a. The network connection 960a allows the transfer of data to and from the mobile device 902. For example, data such as streaming data, instructions, updates and/or notifications can be transferred between the mobile device 902 and the server 930 via the network connection 960a to network 972a.

In FIG. 9A the mobile device 902 is connected to the network 972a of the first MNO 970a using its enabled home profile 905b. The home profile 905b comprises an IMSI which allows connections to be made to the network 972a of the first MNO 970a. It will be appreciated that the first MNO 970a could also identify and grant network access to the mobile device 902 when the mobile device 902 falls back to the bootstrap profile 905a, by inspecting the IMSI of the bootstrap profile 905a when the bootstrap profile 905a has been enabled. However, it may be initially preferred that the mobile device 902 stays connected to the network of the first MNO 970a using the home profile 905b.

During connection of the mobile device to the current network it will be appreciated that the QoE may vary and these characteristics can be sensed or monitored. For example in one period of time it may be determined that the QoE provided by the network connection 960a is poor and/or non-optimal. In other words, the network connection 960a to the network 972a of the first MNO 970a may provide insufficient bandwidth or signal strength for data transfer to and from the mobile device 902. This may be due to a network outage or the mobile device being in an area of poor signal strength. The poor or non-optimal QoE will be reflected in QoE data sent from the mobile device 902 to the connection manager 935 (e.g. in the RSSI data, RSRP data, RSRQ data, SNR data SINR data, SINR data, frequency band data, MCC data, MNC data, changes of RAT, number of dropped calls, number of dropped data sessions, data throughput and/or number of network rejections). As noted above, the connection manager 935 can be remote from the mobile device 902 (see FIG. 9A) or may be local to the mobile device 902.

The connection manager 935 may identify the network connection 960a as providing poor QoE by inspecting data, such as QoE data, received from mobile device 902. The connection manager 935 may determine that higher QoE can be provided by switching to a network 972b of the second MNO 970b. Therefore, the connection manager 935 may determine that the mobile device 902 should connect to the network 972b of the second MNO 970b, in order to improve QoE at the mobile device 902. The connection manager 935 may instruct the mobile device 902 to switch networks. In examples where the connection manager 935 is remote from the mobile device 902 (see FIG. 9A), the instruction to switch networks may be received via the network connection 960a. In examples where the connection manager 935 is local to the mobile device 902, the instruction to switch networks may be generated locally at the mobile device 902.

FIG. 9B shows the mobile device 902 after switching its network connection to a second or preferred network 972b. In this example, switching from the first network connection 960a (FIG. 9A) to the second network connection 960b (FIG. 9B) causes an improvement in QoE at the mobile device 902.

In FIG. 9B the mobile device 902 is in a configuration in which the alternative profile 905c is enabled and the bootstrap profile 905a and the home profile 905b are disabled. The mobile device 902 has a network connection 960b to the network 972b of the second MNO 970b. The network connection 960b allows the transfer of data to and from the mobile device 902. For example, data such as streaming data, instructions, updates and/or notifications can be transferred between the mobile device 902 and the server 930 via the network connection 960b to network 972b.

In FIG. 9B the mobile device 902 is connected to the network 972b of the second MNO 970b using its enabled alternative profile 905c. The alternative profile 905c comprises an IMSI which allows connections to be made to the network 972b of the second MNO 970b. It will be appreciated that the second MNO 970b could also identify and grant network access to the mobile device 902 when the mobile device 902 falls back to the bootstrap profile 905a, by inspecting the IMSI of the bootstrap profile 905a when the bootstrap profile 905a has been enabled. However, it may be preferred under some circumstances that the mobile device 902 connects to the network of the second MNO 970b using the alternative profile 905c.

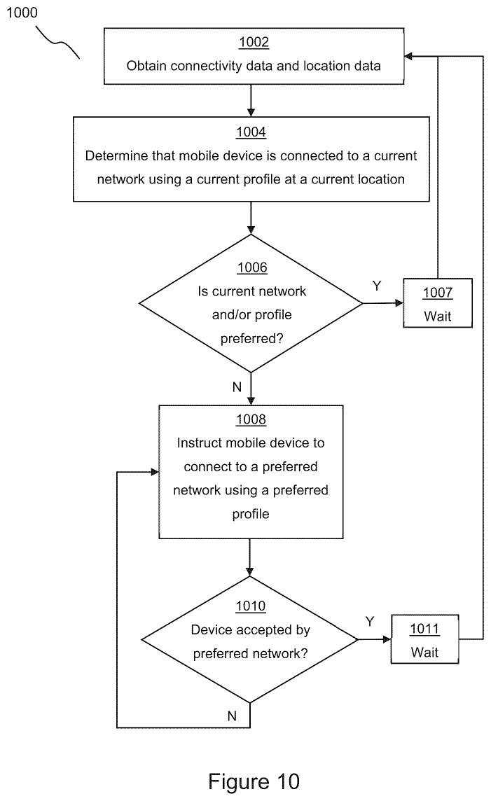

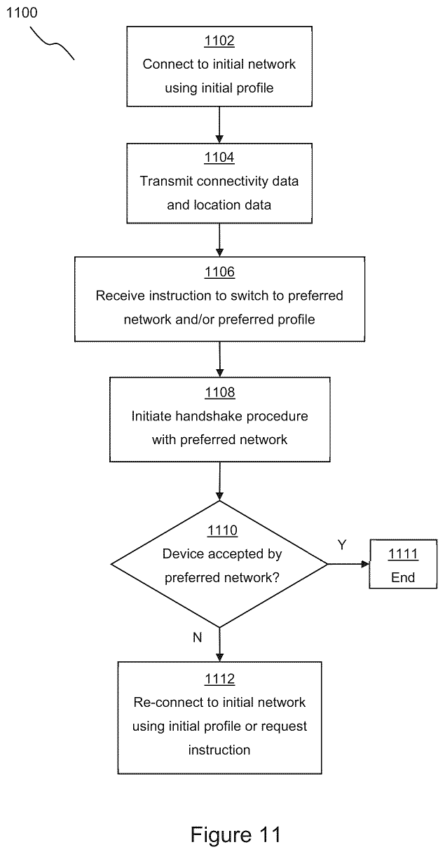

The methods described below in relation to FIGS. 10 and 11 allow dynamic switching between profiles in order to maintain connectivity at a mobile device, improve network resilience and ensure optimised QoE for devices/vehicles in the field. QoE and other data collected by devices/vehicles may be processed to generate insights into network availability and QoE across all available operators. Data analysis of collected QoE metrics can increase network resilience and ensure maximum coverage by: identifying poor or no coverage areas; identifying an optimal carrier in specific locations; identifying poor or no coverage for a current provider; and triggering a profile switch to an identified or preferred carrier.

FIG. 10 discloses an example method 1000 according to an aspect of the invention. The method 1000 can be used to manage network connections at a mobile device configured for communication with a connection manager. The mobile device could be any of the mobile devices 102, 202 and 902 disclosed in FIGS. 1, 2 and 9, and the connection manager could correspond to computer instructions stored on any of the mobile devices 102, 202 and 902 or the servers 130, 230 and 930 disclosed in FIGS. 1, 2 and 9. For brevity, the example method 1000 will be explained with reference to the mobile device 902 and server 930 shown in FIGS. 9A and 9B.

Method 1000 begins at step 1002 in which connectivity data and location data is obtained. For example, the connection manager 935 (located on server 930 or located on the mobile device 902) obtains connectivity data and location data from the mobile device 902. The connectivity data and/or information received from the mobile device 902 includes the current IMSI being used by the mobile device 902, details of the network being used by the mobile device 902, current time data and/or location data for the mobile device 902 and optionally country information for the network being used by the mobile device 902. The location data comprises location data for the mobile device 902, and may be any suitable kind of location data, for example GPS data.

In examples the obtained connectivity data includes QoE data such as one or more of RSSI data, RSRP data, RSRQ data, SNR data, SINR data, frequency band data, MCC data, MNC data, cell data, changes of RAT, number of dropped calls, number of dropped data sessions, data throughput and/or number of network rejections. The connection manager 935 may store the received QoE data with suitable timestamps and associated location data, allowing the connection manager 935 to collect historical QoE data.

The connection manager 935 may obtain connectivity data from a plurality of mobile devices similar to the mobile device 902. Step 1002 may be carried out continuously, i.e. connectivity data and location data may be obtained from one or more mobile devices 902 while the other steps of the method 1000 are being carried out. Collecting data from a plurality of mobile devices 902 is advantageous since it allows the connection manager 935 to look for historical trends in QoE data. The connection manager 935 may be configured to continuously analyse recent (e.g. last 3 months) of received QoE data. The connection manager 935 may be configured to identify operators, locations and time ranges of poor/high radio quality/QoE, and/or to predict poor radio quality/QoE in geo-zones/time ranges. The connection manager 935 may be configured to identify alternative operators for providing better radio quality/QoE in particular geo-zones/time ranges.

The mobile device 902 includes a modem which receives data from the local network infrastructure (e.g. radio cell towers). The connectivity data sent from the mobile device 902 to the connection manager 935 in step may comprise QoE data for each of the networks available at the location of the mobile device 902 (e.g. networks 972a and 972b shown in FIG. 9A). As noted above, the QoE data may include e.g. RSSI data, RSRP data, RSRQ data, SNR data SINR data, SINR data, frequency band data, MCC data, MNC data, changes of RAT, number of dropped calls, number of dropped data sessions, data throughput and/or number of network rejections.

At step 1004, the connection manager 935 determines that the mobile device 902 is connected to a current network using a current profile. Step 1004 may involve inspecting, by the connection manager 935, the connectivity data obtained at step 1002 from the mobile device 902. In the example illustrated in FIG. 9A, at step 1004 the current network is the network 972a provided by the first MNO 970a and the current profile is the home profile 905b.

At step 1006, the connection manager 935 determines whether the current network and the current profile are the preferred network and preferred profile for the mobile device 902. In examples, the connection manager 935 checks whether the current network and current profile provide a suitable QoE for the mobile device 902.

The connection manager 935 can determine whether the current network and the current profile are the preferred network and preferred profile for the mobile device 902 by inspecting data received from the mobile device 902 (or plurality of mobile devices). For example, the connection manager 935 may inspect the connectivity data obtained at 1002. The connection manager 935 uses the received information to determine whether the current network being used (i.e. the network provided by the current MNO) is the preferred network and/or whether the current profile being used (i.e. the profile corresponding to the current IMSI being used) is the preferred profile.

In an example, step 1006 comprises: identifying one or more available networks 972 at the location of the mobile device 902, based on the connectivity data and location data received from the mobile device 902; inspecting QoE data stored at the connection manager 935 for each of the available networks; identifying an available network (e.g. 972b) which can provide an optimal QoE at the location of the mobile device 902 as the preferred network; and determining whether the current network and the preferred network are the same network.

The connection manager 935 may make a rules-based determination of whether the current network and/or current profile are preferred. For example, the connection manager 935 may compare the connectivity data (including the QoE data) with one or more predetermined thresholds stored by the configuration manager 935. Where thresholds are used, the connection manager 935 may determine that the current network and/or current profile are not preferred if the connectivity data such as the QoE falls below a minimum acceptable threshold.

The connection manager 935 may compare QoE data for the current network and current profile with the QoE data for each of the other available networks and profiles. As noted above, QoE data for each of the other available networks may be obtained by the mobile device 902 from the local network infrastructure (e.g. local radio masts). In such examples, the connection manager 935 may identify all of the available networks at the location of the mobile device 902 and identify the available network which can provide an optimal QoE at the location of the mobile device 902 as the preferred network. The connection manager 935 will gather QoE based on radio statistics for available networks. For currently connected network this can be enhanced with current service statistics, as described above. For non-connected networks recent historical service statistics are used to enhance the QoE measurement for decision making purposes.

Additionally, or alternatively, step 1006 may involve identifying, by the connection manager 935, the preferred network by comparing the current location data for the mobile device 902 with historical QoE data for that location. For example, historical QoE data stored at the connection manager 935 may show that a particular network (e.g. network 972a) is likely to provide a low QoE at the current location of the mobile device 902. Additionally, or alternatively, the historical QoE data stored at the connection manager 935 may show that an alternative network (e.g. network 972b) may provide a higher QoE at the current location of the mobile device 902. The connection manager 935 may therefore identify the alternative network which can provide a higher QoE as the preferred network.

Once a preferred network has been identified, connection manager 935 may identify a particular profile as the preferred profile for that preferred network. A preferred profile for each network may be defined in a lookup table which is stored at the connection manager 935. To determine the preferred profile for the preferred network, the connection manager may identify one or more available profiles which would allow the mobile device 902 to connect to the preferred network and identify one of the available profile as the preferred profile based on the lookup table stored at the connection manager 935.

If in step 1006 it is determined that the current profile and/or network are preferred (‘Y’ branch from box 1006 in FIG. 10), then the method 1000 proceeds to step 1007. In step 1007 the connection manager 935 waits for a predetermined amount of time (e.g. 1 minute, 10 minutes, 1 hour or 1 day) before returning to the start of method 1000 (i.e. step 1002). While waiting at step 1007, the mobile device 902 will maintain its connection to the current network using the current profile. Since it is determined that the current profile and/or network are preferred, the current network and profile provide an adequate QoE to the mobile device 902 and there is no need to switch to an alternative network and/or profile.

If in step 1006 it is determined that the current profile and/or network are not preferred (‘N’ branch from box 1006 in FIG. 10), then the method 1000 proceeds to step 1008. In step 1008 the connection manager 935 instructs the mobile device 902 to connect to the preferred network using the preferred profile for that network. For example, the connection manager 935 may send an appropriate instruction to the mobile device 902. In response to the instruction, the mobile device 902 may disconnect from the current network and initiate a handshake procedure with the preferred network.

In the example illustrated in FIG. 9B, the preferred network is the network 972b provided by the second MNO 970b and the preferred profile is the alternative profile 905c. To connect to the network 972b provided by the second MNO 970b using the alternative profile 905c, the mobile device disconnects from the network 972a provided by the first MNO 970a, disables the home profile 905b, enables the alternative profile 905c and initiates a handshake procedure with the second network 972b.

After step 1008, the method 1000 proceeds to step 1010 where it is determined whether the device has been accepted by the preferred network. In examples, the connection manager 935 may poll the mobile device 902 to determine whether a successful connection to the preferred network has been made.

If in step 1010 it is determined that the mobile device 902 has been accepted by the preferred network (‘Y’ branch from box 1010 in FIG. 10), then the method 1000 proceeds to step 1011. In step 1011 the connection manager 935 waits for a predetermined amount of time (e.g. 1 minute, 10 minutes, 1 hour or 1 day) before returning to the start of method 1000 (i.e. step 1002). While waiting at step 1011, the mobile device 902 will maintain its connection to the preferred network using the preferred profile.

If in step 1010 it is determined that the mobile device 902 has not been accepted by the preferred network (‘N’ branch from box 1010 in FIG. 10), then the mobile device 902 may be configured to attempt to re-connect to the initial network using the initial profile (i.e. return to the last known good configuration). For example, where the connection manager is remote from the mobile device 902, the connection manager 935 may be unable to send instructions to the mobile device 902 after the mobile device 902 has disconnected from the initial network (972a) and has not been accepted by the preferred network (972b), and so the mobile device 902 may re-enable the home profile 902b and initiate a handshake procedure with the network 972a of the first MNO 970a.

Alternatively, if in step 1010 it is determined that the mobile device 902 has not been accepted by the preferred network (‘N’ branch from box 1010 in FIG. 10), then the method 1000 may return to step 1008 where the connection manager 935 again instructs the mobile device to connect to a preferred network using a preferred profile for that network. For example, where the connection manager is local to the mobile device 902, the connection manager 935 may instruct the mobile device 902 to attempt to connect to the preferred network. In response to the instruction, the mobile device 902 may initiate a handshake procedure with e.g. the network 972b of the second MNO 970b.

Considering the method 1000 in the context of the example illustrated in FIGS. 9A and 9B, initially the connection manager 935 obtains (step 1002) connectivity data and location data, including QoE data, from a mobile device 902. The connection manager 935 determines (step 1004) that the mobile device 902 is connected to the network provided by the first MNO 970a network using home profile 905b, and that the mobile device 902 is located at a current location (e.g. a current GPS location). The connection manager 935 determines (step 1006) that the network provided by the first MNO 970a and the home profile 905b are not preferred, based on the received QoE data and the location of the mobile device 902. The connection manager 935 instructs (step 1008) the mobile device 902 to connect to the network 972b provided by the second MNO 970b using the alternative profile 905c. The mobile device 902 initiates a handshake procedure with the network 972b provided by the second MNO 970b. If the handshake procedure is successful—i.e. if the mobile device 902 successfully connects to the network 972b provided by the second MNO 970b, as shown in FIG. 9B-then the connection manager 935 waits (step 1011). If the handshake procedure is unsuccessful—i.e. if the mobile device 902 is not able to connect to the network 972b provided by the second MNO 970b—then the mobile device 902 either attempts to re-connect to the network 972a provided by the first MNO 970b using the home profile 905b, or receives a new instruction from the connection manager 935. The new instruction can refer to any suitable network/profile combination (e.g. 970x/905x). For example, the new instruction may be an instruction to connect to the network 972b provided by the second MNO 970b using the alternative profile 905c.

As will be appreciated, method 1000 may be augmented with steps similar to steps 410 and 411 described above, i.e. the method 1000 may additionally include determining, by the connection manager 935, whether or not the eUICC 904 of the mobile device 902 holds the preferred profile and, if not, instructing, by the connection manager 935, the mobile device 902 to download the preferred profile.

FIG. 11 discloses an example method 1100 according to an aspect of the invention. The method 1100 can be used to manage network connections at a mobile device configured for communication with a connection manager. The mobile device could be any of the mobile devices 102, 202 and 902 disclosed in FIGS. 1, 2 and 9, and the connection manager could correspond to computer instructions stored on any of the mobile devices 102, 202 and 902 or the servers 130, 230 and 930 disclosed in FIGS. 1, 2 and 9. For brevity, the example method 1100 will be explained with reference to the mobile device 902 and server 930 shown in FIGS. 9A and 9B.

Method 1100 begins at step 1102 in which the mobile device 902 connects to an initial network using an initial profile. In the example illustrated in FIG. 9A the initial network is the network provided by the first MNO 970a and the initial profile is the home profile 905b.

At step 1104, the mobile device 902 transmits connectivity data and/or location data. For example, the mobile device 902 sends connectivity data to the connection manager 935 periodically, continuously or in response to a request from the connection manager 935. Connectivity data may be sent from the mobile device 902 while the other steps of the method 1100 are being carried out. In the example illustrated in FIG. 9A, the mobile device 902 transmits connectivity data and/or location data to the connection manager 935 via the initial network provided by the first MNO 970a.

The connectivity data sent from the mobile device 902 to the connection manager 935 may comprise QoE data. In particular, the connectivity data may include QoE data such as RSSI data, RSRP data, RSRQ data, SNR data, SINR data, frequency band data, MCC data, MNC data and cell data. The connection manager 935 may store the received QoE data with suitable timestamps and associated location data, allowing the connection manager 935 to collect historical QoE data.

The mobile device 902 includes a modem which receives data from the local network infrastructure (e.g. radio cell towers). The connectivity data sent from the mobile device 902 to the connection manager 935 in step may comprise QoE data for each of the networks available at the location of the mobile device 902 (e.g. networks 972a and 972b shown in FIG. 9A).

At step 1106, the mobile device 902 receives an instruction to connect to a preferred network using a preferred profile for that network. For example, the mobile device 902 may receive the instruction from the connection manager 935, which may be remote from the mobile device 902 (e.g. located on server 930) or local to the mobile device 902. The connection manager 935 may determine the preferred network based on QoE data and/or location data in the manner described above with respect to steps 1006 to 1010 of method 1000. The preferred profile for the preferred network may be determined by the connection manager 935 in the manner described above with respect to steps 1006 to 1010 of method 1000. In the example illustrated in FIG. 9B the preferred network is the network provided by the second MNO 970b and the preferred profile is the alternative profile 905c.

At step 1108, the mobile device 902 initiates a handshake procedure with the preferred network. The handshake procedure may comprise disabling the initial profile and disconnecting from the initial network. The handshake procedure may further comprise enabling the preferred profile and attempting to connect to the preferred network using the preferred profile.

At step 1110 it is determined whether the device has been accepted by the preferred network. In other words, it is determined at step 1110 whether or not the mobile device 902 has successfully connected to the preferred network using the preferred profile. Determining whether the device has been accepted by the preferred network may involve e.g. sending a confirmation message from the mobile device 902 to the connection manager 935 via the connection to the preferred network.

If in step 1110 it is determined that the mobile device 902 has been accepted by the preferred network (‘Y’ branch from box 1110 in FIG. 11), then the method 1100 proceeds to step 1109 where the process ends. At this point, the mobile device 902 is connected to the preferred network using the preferred profile for that network.

If in step 1110 it is determined that the mobile device 902 has not been accepted by the preferred network (‘N’ branch from box 1110 in FIG. 11), then the method 1100 proceeds to step 1112. In step 1112 the mobile device may attempt to re-connect to the initial network using the initial profile. For example, the mobile device 902 may re-enable the home profile and initiate a handshake procedure with the initial network. Once re-connected to the initial network using the initial profile, the mobile device 902 may send a request for a new instruction to the connection manager 935. The request for a new instruction may be a request for an indication of an alternative preferred network and/or alternative preferred profile that the mobile device 902 should try to use in a new connection attempt, in order to optimise QoE at the mobile device 902.

Alternatively, if in step 1110 it is determined that the mobile device 902 has not been accepted by the preferred network (‘N’ branch from box 1010 in FIG. 10), then the mobile device may receive a further instruction from the connection manager 935 to connect to the preferred network using the preferred profile for that network. For example, where the connection manager is local to the mobile device 902, the connection manager 935 may instruct the mobile device 902 to re-attempt to connect to the network 272b. In response to the instruction, the mobile device 902 may initiate a handshake procedure with the network 972b of the second MNO 970b.

Considering the method 1100 in the context of the example illustrated in FIGS. 9A and 9B, the mobile device 902 initially connects (step 1102) to the network provided by the first MNO 970a using the home profile 905b, for example via a handshake procedure. Once connected to the network provided by the first MNO 970a using the home profile 905b, the mobile device transmits (step 1104) connectivity data, including QoE data, and location data to the connection manager 935. The mobile device 902 receives (step 1106) an instruction from the connection manager 935 to switch to a preferred network/profile which in this case is the network 972b provided by the second MNO 970b and the alternative profile 905c. The mobile device 902 disconnects from the network 972a provided by the first MNO 970a disables the home profile 905b, enables the alternative profile 905c and initiates a handshake procedure (step 1108) with the network 972b provided by the second MNO 970b. If the handshake procedure is successful—i.e. if the mobile device 902 successfully connects to the network 972b provided by the second MNO 970b—then the method ends (step 1111). If the handshake procedure is unsuccessful—i.e. if the mobile device 902 is not able to connect to the network 972b provided by the second MNO 970b-then the mobile device 902 either attempts to re-connect to the network 972a provided by the first MNO 970b using the home profile 905b, or receives a new instruction from the connection manager 935. The new instruction can refer to any suitable network/profile combination (e.g. 970x/905x). For example, the new instruction may be an instruction to connect to e.g. the network 972b provided by the second MNO 970b using the alternative profile 905c.

As will be appreciated, method 1100 may be augmented with steps similar to steps 812 to 816 described above, i.e. the method 1100 may additionally include determining whether or not the eUICC 904 of the mobile device 902 holds the preferred profile for the preferred network and, if not, downloading the alternative profile.

Modifications can be made to that herein described without departing from scope of the present application which is intended to be limited only insofar as is necessary in the light of the claims that follow. For example, the methods 300, 400, 600, 700 and 800 described herein may be adapted to situations in which a mobile device uses a non-preferred profile (rather than the bootstrap profile) to connect to a network. In such examples the connectivity threshold may be met when the mobile device has used the non-preferred profile for a predetermined amount of time. The mobile device 102, 202, 902 may be any suitable mobile computing device, such as a NAD or modem locatable in a vehicle. Alternatively the mobile device 102, 202, 902 may be hardware components of the vehicle which allow the vehicle to connect to a network, such as a cellular or radio access network. Alternatively the mobile device 102, 202, 902 may be a user device such as a mobile phone, tablet or laptop, which may be locatable within a vehicle and which may be configured to provide a local network within a vehicle.

The words comprises/comprising when used in this specification are to specify the presence of stated features, integers, steps or components but does not preclude the presence or addition of one or more other features, integers, steps, components or groups thereof.

1. A method of managing network connections at a mobile device, the mobile device comprising an embedded subscriber identity module, eSIM, comprising at least a first profile, the first profile comprising at least one international mobile subscriber identifier, IMSI, the mobile device being configured for communication with a connection manager configured for monitoring Quality of Experience, QoE, data, the method comprising:
obtaining, by the connection manager, connectivity data and location data from the mobile device, wherein the connectivity data comprises QoE data and wherein the location data comprises location data for the mobile device;
determining, by the connection manager, that the mobile device is connected to a current network using an IMSI of a current profile;
determining, by the connection manager, whether the current network is a preferred network and/or whether the current profile is a preferred profile based on the QoE data and the location data; and
instructing, by the connection manager, the mobile device to connect to the preferred network using an IMSI of the preferred profile in response to determining that the current network is not the preferred network and/or in response to determining that the current profile is not the preferred profile.

2. A method according to claim 1, wherein determining whether the current network is the preferred network comprises:
identifying one or more available networks at the location of the mobile device;
inspecting QoE data stored at the connection manager for each of the available networks;
identifying an available network which can provide an optimal QoE at the location as the preferred network; and
determining whether the current network and the preferred network are the same network.

3. A method according to claim 2, wherein determining whether the current profile is the preferred profile comprises:
identifying one or more available profiles which would allow the mobile device to connect to the preferred network;
identifying, based on a lookup table, an available profile as the preferred profile.

4. A method according to claim 1, wherein the QoE data comprises at least one of: Received Signal Strength Indicator, RSSI, data; Reference Signal Received Power, RSRP, data; Reference Signal Received Quality, RSRQ, data; Signal-to-Noise Ratio, SNR, data; Signal to Interference and Noise Ratio, SINR, data; frequency band data; Mobile Country Code, MCC, data; Mobile Network Code, MNC, data; cell data; changes of RAT; number of dropped calls; number of dropped data sessions; data throughput; and/or number of network rejections.

5. A method according to claim 1, wherein the method further comprises
determining, by the connection manager, that the eSIM does not comprise the preferred profile; and
instructing, by the connection manager, the mobile device to download the preferred profile.

6. A method according to claim 1, wherein the mobile device is a network access device.

7. A method according to claim 1, wherein the eSIM is an M2M eUICC.

8. A method according to claim 1, wherein the mobile device is, or is located in, a network-enabled vehicle such as a car, truck, drone or plane.

9. A method according to claim 1, wherein the current profile is a bootstrap profile.

10. A method according to claim 1, wherein the connection manager stores a plurality of QoE thresholds.

11. A connection manager configured for managing network connections at a mobile device, the mobile device comprising an embedded subscriber identity module, eSIM, comprising at least a first profile, the first profile comprising at least one international mobile subscriber identifier, IMSI, the mobile device being configured for communication with the connection manager, the connection manager being configured for monitoring Quality of Experience, QoE, data, the connection manager comprising one or more processors and memory, wherein the memory comprises computer instructions that, when executed by the one or more processors, are configured to cause the connection manager to:
obtain connectivity data and location data from a mobile device, wherein the connectivity data comprises QoE data and wherein the location data comprises location data for the mobile device;
determine that the mobile device is connected to a current network using an IMSI of a current profile;
determine whether the current network is a preferred network based on the QoE data and the location data; and
instruct the mobile device to connect to the preferred network using an IMSI of the preferred profile.

12. A connection manager according to claim 11, wherein the connection manager is located on a server.

13. A connection manager according to claim 11, wherein the connection manager is located on the mobile device.

14. A method of managing network connections at a mobile device, the mobile device comprising an embedded subscriber identity module, eSIM, comprising at least a first profile, the first profile comprising at least one international mobile subscriber identifier, IMSI, the mobile device being configured for communication with a connection manager configured for monitoring Quality of Experience, QoE, data, the method comprising:
connecting, by the mobile device, to an initial network using an IMSI of an initial profile;
transmitting, by the mobile device to the connection manager, connectivity data and location data, wherein the connectivity data comprises QoE data and wherein the location data comprises location data for the mobile device;
receiving, by the mobile device and from the connection manager, an instruction to connect to a preferred network using an IMSI of a preferred profile; and
attempting, by the mobile device, to connect the preferred network using an IMSI of the preferred profile.

15. A method according to claim 14, wherein attempting to connect to the preferred network using an IMSI of the preferred profile comprises initiating a handshake procedure with the preferred network.

16. A method according to claim 14, wherein the method further comprises re-connecting to the initial network using the initial profile in response to a failure to connect the preferred network using an IMSI of the preferred profile.

17. A method according to claim 14, wherein the method further comprises:
receiving, by the mobile device and from the connection manager, an instruction to download the preferred profile.

18. A method according to claim 14, wherein the mobile device is, or is located in, a network-enabled vehicle such as a car, truck, drone or plane.

19. A method according to claim 14, wherein the eSIM is an M2M eUICC.

20. A method according to claim 14, wherein a current profile is a bootstrap profile.
